(19) United States
(12) Patent Application Publication
(10) Pub. No.: US 2020/0117893 A1
(43) Pub. Date: Apr. 16, 2020

(54) DETERMINING DIFFERENCES IN DOCUMENTS TO GENERATE A VISUALIZATION HIGHLIGHTING THE DIFFERENCES BETWEEN DOCUMENTS

(71) Applicant: International Business Machines Corporation, Armonk, NY (US)

(72) Inventors: Phillip Whelan, Ottawa (CA); Paul C. Jones, Ottawa (CA); Amit Joneja, Ottawa (CA); Gregory J. Koestler, Ottawa (CA)

(21) Appl. No.: 16/162,384

(22) Filed: Oct. 16, 2018

(51) Int. Cl. G06K 9/00; G06F 17/22

(52) U.S. Cl. CPC G06K 9/00483; G06K 9/00476; G06F 17/2211

(57) ABSTRACT

Provided are a computer program product, system, and method for determining differences in documents to generate a visualization highlighting the differences between documents. Name-value pairs are extracted for objects in a first document. The objects include code to control rendering of content in the first document in a graphical user interface (GUI). Each extracted name-value pair indicates a value for a name of an attribute in the first document. Name value pairs are extracted for objects in a second document. A determination is made whether a difference in values of a specified name indicated in the name-value pairs extracted from the first and second documents exceeds a threshold provided for the specified name. A visualization is generated highlighting an object rendered according to different values provided for the specified name that are determined to exceed the threshold provided for the specified name.

### BACKGROUND OF THE INVENTION

### 1. Field of the Invention

The present invention relates to a computer program product, system, and method for determining differences in documents to generate a visualization highlighting the differences between documents.

### 2. Description of the Related Art

Developers of web pages and program user interfaces use various tools to determine differences in how different versions of a user interface page are displayed in a web browser or other computer user interface. Some tools allow identification of the portions of code providing display attributes to control the display of content, such as positional and stylistic information, and may display the differences in the code for displaying content between the versions of the user interface. Other programs create images that show differences between the visual output of two documents to assist the developer in further modifying the document to an optimal visualization.

There is a need in the art for improved techniques for providing information on differences between documents and how the documents render output.

### SUMMARY

Provided are a computer program product, system, and method for determining differences in documents to generate a visualization highlighting the differences between documents. Name-value pairs are extracted for objects in a first document. The objects include code to control rendering of content in the first document in a graphical user interface (GUI). Each extracted name-value pair indicates a value for a name of an attribute in the first document. Name value pairs are extracted for objects in a second document. A determination is made whether a difference in values of a specified name indicated in the name-value pairs extracted from the first and second documents exceeds a threshold provided for the specified name. A visualization is generated highlighting an object rendered according to different values provided for the specified name that are determined to exceed the threshold provided for the specified name.

### BRIEF DESCRIPTION OF THE DRAWINGS

FIG. 1 illustrates an embodiment of a computing environment in which changes to a document are visualized.

FIG. 2 illustrates an embodiment of a display object.

FIG. 3 illustrates an embodiment of object name thresholds for a display object.

FIG. 4 illustrates an embodiment of a name threshold included in an object name thresholds.

FIGS. 5a and 5b illustrate an embodiment of operations to log differences in display objects in first and second documents in a results document.

FIG. 6 illustrates an example of a results document.

FIG. 7 illustrates an example of a differences visualization GUI.

FIG. 8 illustrates an embodiment of operations to render visualizations of differences between first and second documents in a differences visualization GUI.

FIG. 9 illustrates an embodiment of operations for a user to adjust thresholds for object names to determine whether differences for display objects should be visually highlighted.

FIG. 10 illustrates a computing environment in which the components of FIG. 1 may be implemented.

### DETAILED DESCRIPTION

Comparison tools illustrate and allow visualizations of differences in code and the rendering of content for documents that are rendered in a computer user interface, such as a web browser or application window. These comparison tools may highlight or provide visualizations of differences in the code, or display attributes, even for visual differences that are barely noticeable or that that the developer is not interested in considering.

Described embodiments provide improvements to computer technology for comparing documents and providing visualizations of the differences in documents by extracting from first and second documents name-value pairs of display attributes for the objects. A determination is made of values of a specified name indicated in the name-value-pairs extracted from the first and second documents and whether the difference in the values between the documents exceed a threshold provided for the specified name. A visualization is generated highlighting an object rendered according to the different values provided for the specified name that are determined to exceed the threshold provided for the specified name.

The described embodiments provide improvements to computer technology for rendering visualizations highlighting differences in display objects from first and second documents when the values for display attributes of the display objects, such as position and stylistic information, exceeds thresholds. In this way, visualizations highlighting differences are not provided for differences in display attribute name-value pairs that do not exceed thresholds provided for a name of a display attribute because such differences that do not exceed the threshold are deemed to have a minimal impact on the visualization of the objects.

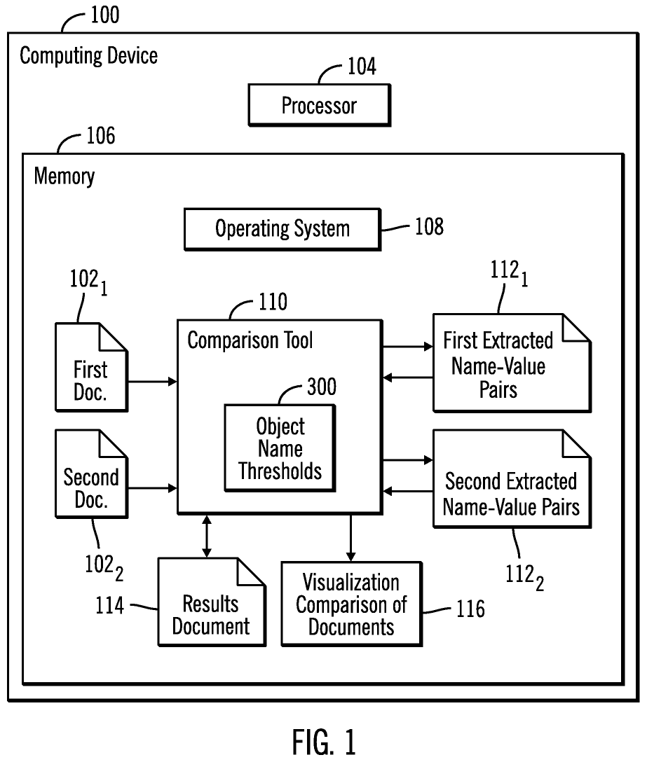

FIG. 1 illustrates an embodiment of a computing device 100 for providing a visualization of differences between first 102₁ and second 102₂ documents. The computing device 100 includes a processor 104 and a memory 106 including an operating system 108 and a comparison tool 110 to perform the comparison operations to visually highlight differences in the layout and format of the documents 102₁, 102₂. The documents have display attributes to control the layout and presentation of display objects in the documents 102₁, 102₂, such as font size, shape of an object, coordinates, size, title dimensions, etc. The comparison tool 110 extracts name-value pairs for the display attribute values in the documents 102₁, 102₂ to generate first extracted name value-pairs 112₁ from the first document 102₁ and second extracted name value-pairs 112₂ from the second document 102₂. The extracted first 112₁ and second 112₂name value pairs may be stored in an open standard file format file, such as JavaScript Object Notation (JSON). The format in which the extracted name-value pairs 112₁, 112₂ are stored may comprise a common data format used for asynchronous browser communication.

The extracted name-value pairs each provide a value for a display attribute (name), such as a string of unicode characters. The name value-pairs may be organized into objects, where each object may represent a display object to render in the documents 102₁, 102₂ and the name-value pairs that provide display attributes to control how the object is displayed in a rendering of the documents 102₁, 102₂, such as position, size, shape, font, color, etc.

The comparison tool 110 processes the name value-pairs in the first 112₁ and second 112₂ extracted name-value pairs to generate a results document 114 having information on those name-value pairs that provide different values for a same name. The comparison tool 110 may maintain object name thresholds 300, such that for each display object, only name-value pairs having value differences between the first 112₁ and second 112₂ extracted name-value pairs that exceed a threshold for a name are included in the results document 114. In this way, only name-value pair differences for a display object having a difference exceeding the threshold are included in the results document 114. The comparison tool 110 processes the results document 114 to generate a visualization of a comparison of the documents 116 that highlighting differences of the display objects documents 102₁, 102₂ as indicated in the results document 114.

The arrows shown in FIG. 1 show a data flow between generated data structures and the comparison tool 110.

The memory 106 may comprise any suitable volatile or non-volatile memory device storing programs and data structures accessed by the processor 104.

Generally, program modules, such as the program components 108 and 110, and any others described herein, may comprise routines, programs, objects, components, logic, data structures, and so on that perform particular tasks or implement particular abstract data types. The program modules may be practiced in distributed cloud computing environments where tasks are performed by remote processing devices that are linked through a communications network. In a distributed cloud computing environment, program modules may be located in both local and remote computer system storage media including memory storage devices.

The program components and hardware devices of the computing device 100 may be implemented in one or more computer systems, where if they are implemented in multiple computer systems, then the computer systems may communicate over a network.

The program components 108 and 110 and any others described herein, may be accessed by a processor from memory to execute. Alternatively, some or all of the program components 108 and 110, and any others described herein, may be implemented in separate hardware devices, such as Application Specific Integrated Circuit (ASIC) hardware devices.

The functions described as performed by the program components 108 and 110, and any others described herein, may be implemented as program code in fewer program modules than shown or implemented as program code throughout a greater number of program modules than shown.

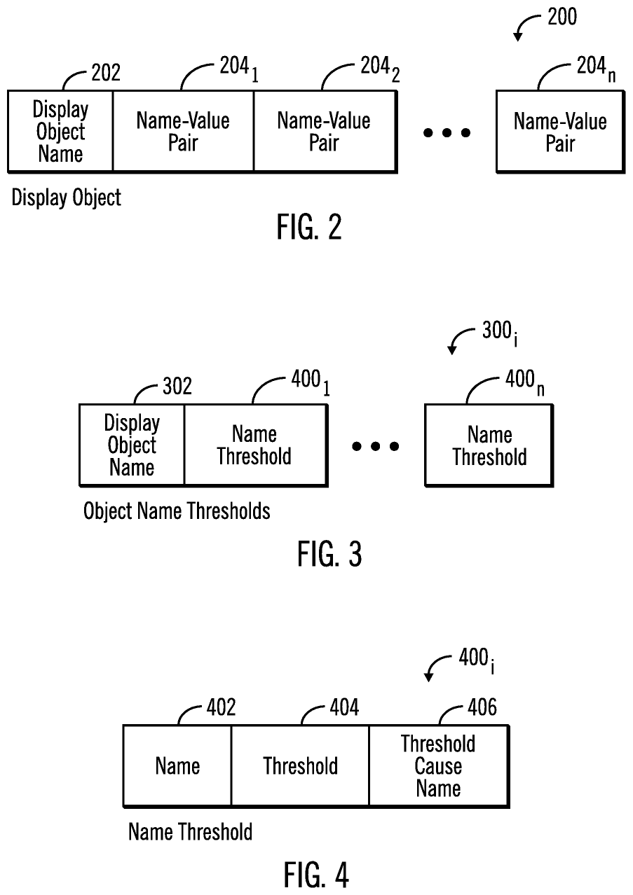

FIG. 2 illustrates an embodiment of a display object 200 included in the extracted name-value pairs 112₁, 112₂ for each display object indicated in the documents 102₁, 102₂, and includes a display object name 202 and one or more name-value pairs 204₁, 204₂ . . . 204ₙ providing display attributes to control the presentation and layout of the display object in the documents 102₁, 102₂. In described embodiments, the display object represents an object displayed in the documents 102₁, 102₂ and the name-value pairs of the object comprise display attributes to control how the display object is rendered. In further embodiments, the object may provide name-value pairs for object types other than a display object and for information other than display attributes.

FIG. 3 illustrates an embodiment of an instance of an object name thresholds 300ᵢ, in the object name thresholds 300, for one of the display objects 200, and includes an object name 302 and one or more name thresholds 400₁, 400₂ . . . 400ₙ for one or more of the name-value pairs 204₁, 204₂ . . . 204ₙ in an object. The name threshold 304₁ are optional, and if no threshold is provided for a name, than any difference in the values for that named display attribute in the first 102₁ and second 102₂ documents is included in the results document 114.

FIG. 4 illustrates an embodiment of an instance of a name threshold 400ᵢ specified for a name in an object, and includes a name 402 of a name-value pair for which the threshold is provided; a threshold 404 indicating a value that must be satisfied in order for a difference of name values in the first 102₁ and second 102₂ documents to be added to the results document 114; and a threshold cause name 406, indicating a name-value pair that must change between the first 102₁ and second 102₂ documents in order to include a difference of values for the name 402 in the results document 114. The threshold cause name 406 may identify a name-value pair other than the name value-pair 402 for which the threshold 404 is provided, such as the name-value pair whose changes cause changes in the name-value pair 402 for which the threshold is provided. The threshold cause name 406 may not be provided for a threshold 404, such that the name-values are indicated in the results document 114 if the difference in values for the name 402 exceeds the threshold regardless of the cause of the difference.

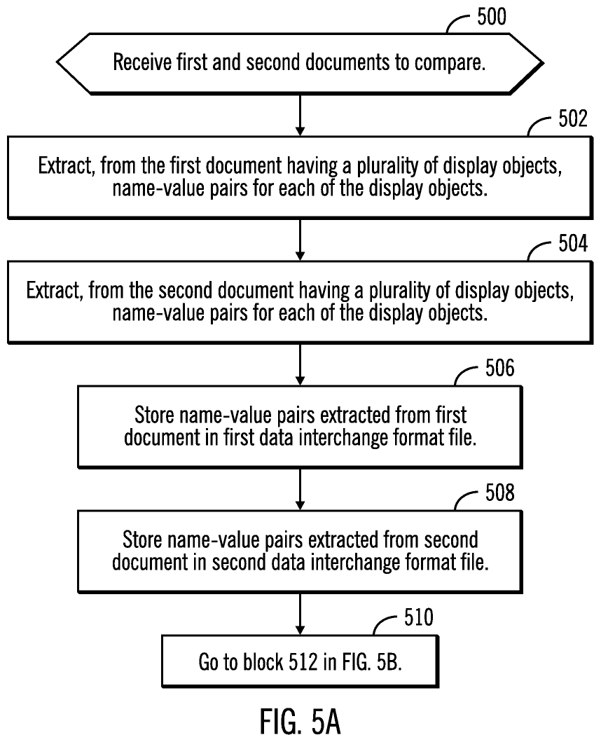

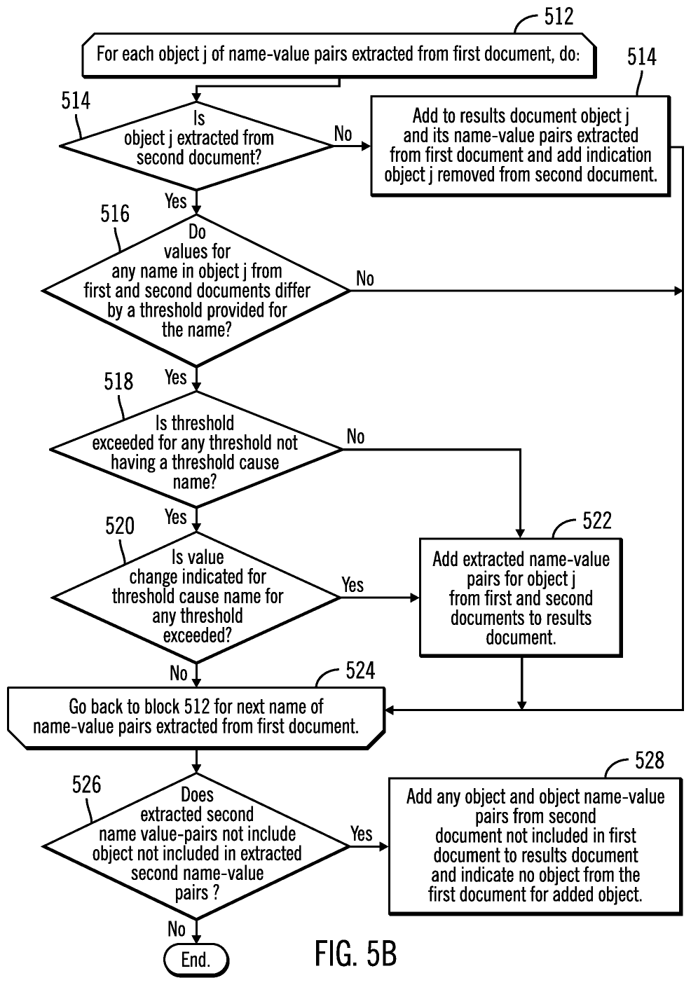

FIGS. 5a and 5b illustrate an embodiment of operations performed by the comparison tool 110 to compare the first 102₁ and second 102₂ to generate the results document 114. Upon receiving the first 102₁ and second 102₂ to process, the comparison tool 110 extracts (at block 502), from the first document 102₁, having a plurality of display objects, name-value pairs 204, for each of the display objects 200 and extracts (at block 504), from the second document 102₂, having a plurality of display objects, name-value pairs 204, for each of the display objects 200. The name-value pairs for display objects 200 extracted from the first 102₁ and second 102₂ documents are stored (at blocks 506 and 508) in a first 112₁ and second 112₂ data interchange format files, such as a JSON format file. Control then proceeds (at block 510) to block 512 in FIG. 5b.

With respect to FIG. 5b, a loop of operations is performed at blocks 512-524 for each display object j of name-value pairs 204, extracted from the first document 102₁. If (at block 512) object j was not extracted from the second document 102₂, as indicated by being present in second extracted name value pairs 112₂, which means the object j was removed from the second document 102₂, then the object j extracted from the first document 102₁ is added (at block 514) to the results document 114 and indication is made object j was removed from the second document 102₂. If (at block 514) the object j was extracted from the second document 102₂, then the comparison tool 110 determines (at block 516) whether the values for any name-value pair 204ᵢ in object j from the first 102₁ and second 102₂ documents differ by a threshold 404 provided for the name, where a threshold is optional. If (at block 516) the value differences in the extracted name-value pairs 112₁, 112₂ for one name-value pairs 204ᵢ for object j exceed a threshold and if (at block 518) no threshold 404 has a threshold cause name 406, then the comparison tool 110 adds (at block 522) the name-value pairs 204ᵢ for object j from the extracted first 102₁ and second 102₂ documents to the results document 114.

If (at block 518) no threshold is exceeded that does not have a threshold cause name 406, then the comparison tool 110 determines (at block 520) whether a change between documents is indicated for the values for the threshold cause name 406 extracted from documents. If (at block 520) a threshold 404 being exceeded having a cause 406 was caused by the threshold cause name name-value pair, i.e., the name-value pair for the threshold cause name 406 changes between the extracted first 112₁ and second 112₂ name-value pairs, then control proceeds to block 522 to add all the name-value pairs of object j from the extracted first 112₁ and second 112₂ name-value pairs, including those not having a threshold exceeded or having a threshold exceeded but not by the specified threshold cause name 406. After processing object j from block 514 or 522 or from the no branch of block 520, control proceeds (at block 524) back to block 512 until all objects in the extracted first name-value pairs 112₁ are processed. After processing all the display objects, if (at block 526) the extracted second name-value pairs 112₂ from the second document 102₂ includes a display object 200 not found in the extracted first name-value pairs 112₁, then the comparison tool 110 adds (at block 528) any object and object name-value pairs in the second extracted name-value pairs 112₂ from the second document 102₂ that are not included in the first extracted name-value pairs 112₁ to the results document 114.

The embodiments of FIGS. 5a and 5b provide improvements to computer technology for generating a file indicating differences in display objects from multiple documents. The described embodiments extract name-value pairs for display attributes from the different documents to data interchange format files, such as JSON files, which have the same format for specifying the name-value pairs. This allows for comparison of the data interchange format, e.g., JSON files, to determine those display objects or attributes that are different in the documents 102₁, 102₂ for further consideration. The transformation of the name-value pairs in the source documents 102₁, 102₂ to a common data interface format files, such as a JSON file format, allows for direct comparison of the name value pairs extracted from the documents to determine whether any differences exceed thresholds. The thresholds provided for certain name-value pairs ensures visualizations to highlight are only performed for differences that exceed a threshold provided for the name-value pair indicating whether a difference in a display attribute value is sufficient enough to have the difference rendered in the visualization 116.

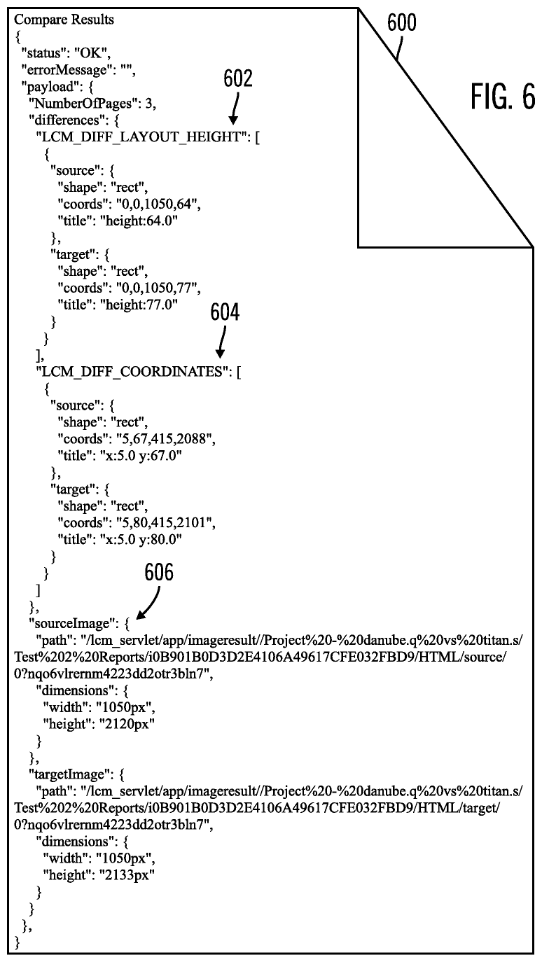

FIG. 6 illustrates an example of the results document 114, which provides name-value pairs for different types of objects 602, 604, and 606 that have different values in the documents 102₁, 102₂. For instance, the entries for display objects 602 and 604 show that the display object of a rectangle in the source and target documents has different coordinates where positioned in the documents and the tile has different heights. For display object 606 which displays an object at a path, the height of objects for content at a same path are displayed differently.

If name-value pairs from the source documents 102₁, 102₂ are not included in objects 200ᵢ, then such unaffiliated name-value pairs satisfying threshold difference requirements may be added to the results document 114 separately.

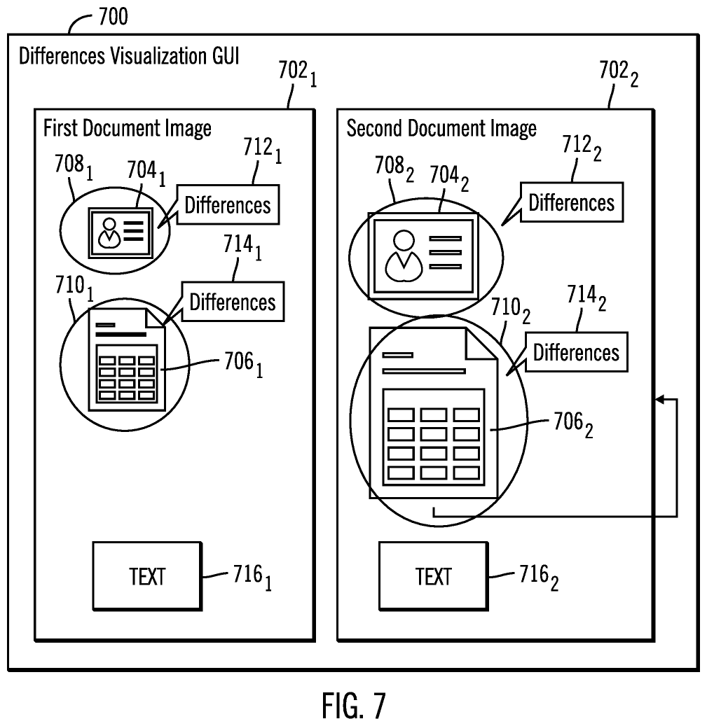

FIG. 7 illustrates an example of the visualization comparison 116 in a differences visualization GUI 700 including a first document image 702₁ rendering the content in the first document 102₁ according to the display attributes and a second document image 702₂ rendering the content in the second document 102₂ according to the display attributes. Both rendered documents 702₁, 702₂ each include objects 704₁, 704₂ and 706₁, 706₂ having different display characteristics, such as different sizes. Both objects in the documents 702₁, 702₂ are highlighted with highlights 708₁, 708₂ and 710₁, 710₂, and textual information on the differences is also rendered 712₁, 712₂ and 714₁, 714₂. The display object 716₁, 716₂ is shown without highlights because the display object for object 716₁, 716₂ has no name-value pair differences to visually highlight and may not be indicated the results document 114. In FIG. 7, the highlights 708₁, 708₂ and 710₁, 710₂ are shown as circles of the changed objects. In further embodiments, other highlighting techniques may be used such as different coloring, different shading, an active image, etc.

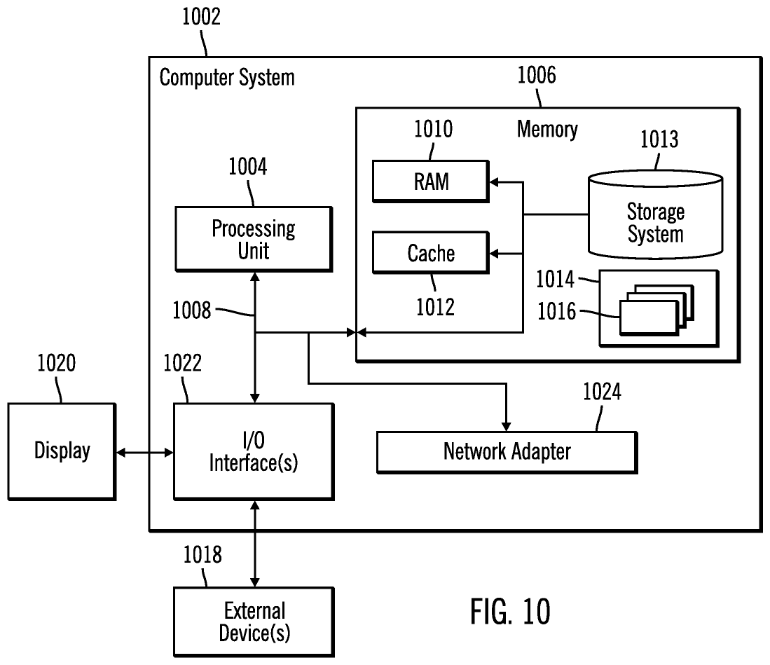

The visualizations 116 and 700 comprise code that when executed by the computing device 100 render visualizations on a display monitor 1020 (FIG. 10) to be observable by a user.

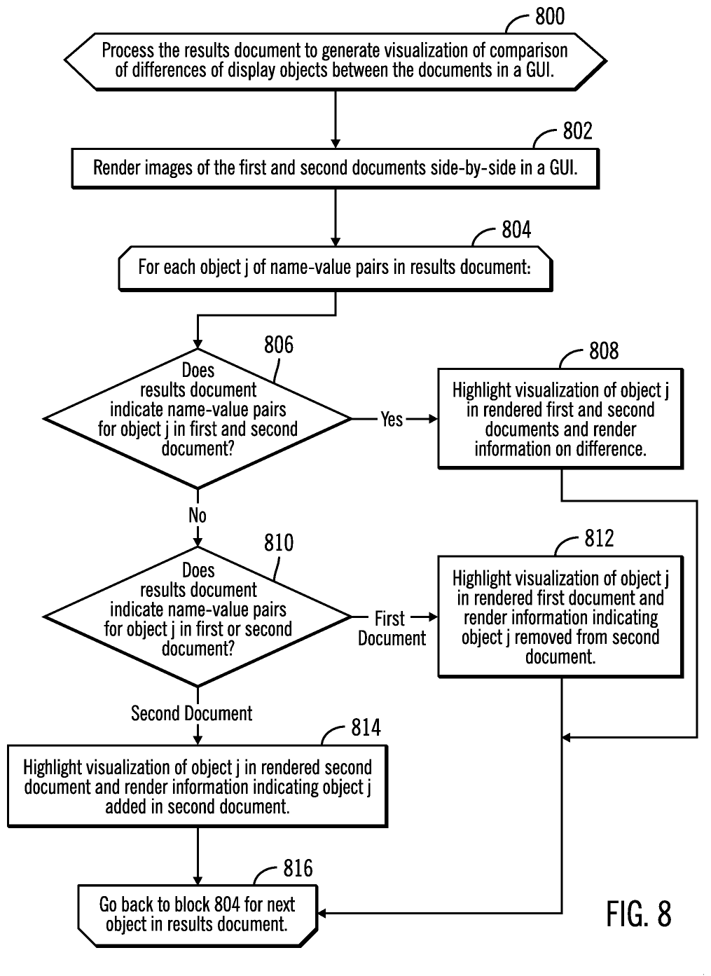

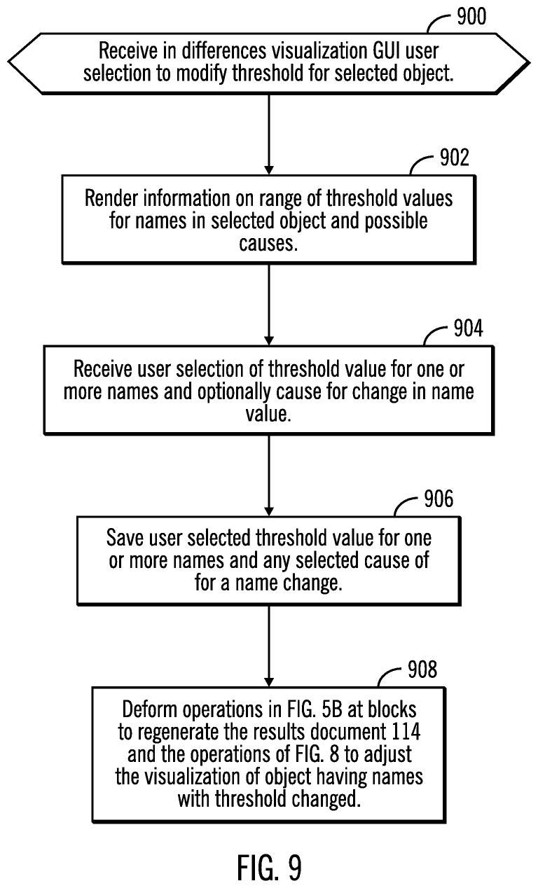

FIG. 8 illustrates an embodiment of operations to process the results document 114 to generate a visualization comparing differences of display objects between the documents in a GUI 116. Upon processing (at block 800) the results document 114, the comparison tool 110 renders (at block 802) images of the first 702₁ and second 702₂ documents side-by-side in the differences visualization 700 GUI, where images are rendering according to the display attributes coded in the display objects 200 in the documents 102₁, 102₂. A loop of operations is performed at blocks 804-816 for each object j in the results document 114 having differences in values in the documents 102₁, 102₂. If (at block 806) the results document 114 indicates name value pairs 204ᵢ for a display object in first 102₁ and second 102₂ documents, then the comparison tool 110 highlights (at block 808) the visualization of object j rendered in the first and second documents, e.g., highlights 708₁, 708₂ and 710₁, 710₂, in the visualization 700 and renders textual information on the objects having differences (e.g., 712₁, 712₂ and ⁷¹⁴₁, 714₂). For instance, the display object j in both documents may be outlined or highlighted in a different color shading to draw user attention with graphics to the object j having differences in the rendered documents 702₁, 702₂. The textual information may provide information explaining the differences, such as different height, shape, font, etc.

If (at block 806) object j is not indicated in the results document 114 for both the first and second documents, then the comparison tool 110 determines (at block 810) whether the results document 114 indicates name-value pairs for object j in one of the first 102₁ and second document. If (at block 810) object j is provided for the first document 102₁, then the comparison tool 110 highlights (at block 812) a visualization of object j in rendered first document 702ᵢ and render information indicating object j removed from second document. If (at block 810) object j is provided for the second document 102₂, then the comparison tool 110 highlights (at block 814) visualization of object j in rendered second document 702₂ and render information indicating object j added in the second document 102₂.

The embodiment of operations of FIG. 8 provides improvements to computer display technology for highlighting differences in objects in compared documents by rendering images of the two documents and then highlighting those objects that have different display attributes with textual information on the differences. This allows a developer of content for web pages or other computer display to compare how the visualization of objects in the documents has changed between the documents when the differences exceed certain thresholds. These visualizations of changes provides information to the developer to use to determine whether further changes need to be made to the changed or second document 102₂.

FIG. 9 illustrates an embodiment of operations performed by the comparison tool 110 to allow a user to specify changes to object name thresholds 300ᵢ used to determine whether to indicate changes in a visualization 116, 700. Upon receiving (at block 900) in the differences visualization GUI 700 user selection to modify thresholds 300ᵢ of names 400ᵢ for a selected object, the comparison tool 110 renders (at block 902) information on a range of possible threshold values for the names in the selected objects and possible causes. The comparison tool 110 receives (at block 904) through the differences visualization GUI 700 user selection of a threshold value for the threshold for one or more names of the object and optionally a cause for the change. The user selected threshold value 404 for one or more names and any selected threshold cause name 406 are saved (at block 906). The comparison tool 110 may perform (at block 908) the operations in FIG. 5b to regenerate the differences in the results document 114 to consider the new thresholds 404 and causes 406 provided by the user through the differences visualization GUI 700 and the operations of FIG. 8 to adjust the visualization 700 of the objects having values for names with thresholds exceeded to allow the user to see the changes with the new thresholds, i.e., more or less differences visualized.

The embodiment of FIG. 9 provides improvements to computer technology for allowing a user to generate visualizations of changes to display objects in a document by allowing the user to specify change thresholds based on the current visualization to adjust whether certain changes should not be visualized unless the threshold of the differences is greater to only display certain changes whose difference exceeds a threshold.

In the embodiment of FIGS. 5a and 5b and 7, the differences in values for a name are compared to the threshold when determining whether to include the objects 200 having different values for names 204ᵢ in the results document 114. In an alternative embodiment, all differences of objects having different values for names may be recorded in the results document 114 without considering thresholds, and then the thresholds 300ᵢ are considered when determining whether to render a visualization of the difference for the displayed object, such that only differences in the results document 114 exceeding a threshold 400ᵢ are rendered in the visualization 116, 700.

The reference characters used herein, such as i, j, and n, and any others, are used to denote a variable number of instances of an element, which may represent the same or different values, and may represent the same or different value when used with different or the same elements in different described instances.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computational components of FIG. 1, including the computing device 100 may be implemented in one or more computer systems, such as the computer system 1002 shown in FIG. 10. Computer system/server 1002 may be described in the general context of computer system executable instructions, such as program modules, being executed by a computer system. Generally, program modules may include routines, programs, objects, components, logic, data structures, and so on that perform particular tasks or implement particular abstract data types. Computer system/server 1002 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, the computer system/server 1002 is shown in the form of a general-purpose computing device. The components of computer system/server 1002 may include, but are not limited to, one or more processors or processing units 1004, a system memory 1006, and a bus 1008 that couples various system components including system memory 1006 to processor 1004. Bus 1008 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1002 typically includes a variety of computer system readable media. Such media may be any available media that is accessible by computer system/server 1002, and it includes both volatile and non-volatile media, removable and non-removable media.

System memory 1006 can include computer system readable media in the form of volatile memory, such as random access memory (RAM) 1010 and/or cache memory 1012. Computer system/server 1002 may further include other removable/non-removable, volatile/non-volatile computer system storage media. By way of example only, storage system 1013 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1008 by one or more data media interfaces. As will be further depicted and described below, memory 1006 may include at least one program product having a set (e.g., at least one) of program modules that are configured to carry out the functions of embodiments of the invention.

Program/utility 1014, having a set (at least one) of program modules 1016, may be stored in memory 1006 by way of example, and not limitation, as well as an operating system, one or more application programs, other program modules, and program data. Each of the operating system, one or more application programs, other program modules, and program data or some combination thereof, may include an implementation of a networking environment. The components of the computer 1002 may be implemented as program modules 1016 which generally carry out the functions and/or methodologies of embodiments of the invention as described herein. The systems of FIG. 1 may be implemented in one or more computer systems 1002, where if they are implemented in multiple computer systems 1002, then the computer systems may communicate over a network.

Computer system/server 1002 may also communicate with one or more external devices 1018 such as a keyboard, a pointing device, a display 1020, etc.; one or more devices that enable a user to interact with computer system/server 1002; and/or any devices (e.g., network card, modem, etc.) that enable computer system/server 1002 to communicate with one or more other computing devices. Such communication can occur via Input/Output (I/O) interfaces 1022. Still yet, computer system/server 1002 can communicate with one or more networks such as a local area network (LAN), a general wide area network (WAN), and/or a public network (e.g., the Internet) via network adapter 1024. As depicted, network adapter 1024 communicates with the other components of computer system/server 1002 via bus 1008. It should be understood that although not shown, other hardware and/or software components could be used in conjunction with computer system/server 1002. Examples, include, but are not limited to: microcode, device drivers, redundant processing units, external disk drive arrays, RAID systems, tape drives, and data archival storage systems, etc.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for comparing documents, wherein the computer program product comprises a computer readable storage medium having program instructions embodied therewith, the program instructions executable by a processor to cause operations, the operations comprising:
extracting name-value pairs for objects in a first document, wherein the objects include code to control rendering of content in the first document in a graphical user interface (GUI), wherein each extracted name-value pair indicates a value for a name of an attribute in the first document;
extracting name value pairs for objects in a second document,;
determining whether a difference in values of a specified name indicated in the name-value pairs extracted from the first and second documents exceeds a threshold provided for the specified name; and
generating a visualization highlighting an object rendered according to different values provided for the specified name that are determined to exceed the threshold provided for the specified name.

2. The computer program product of claim 1, wherein the operations further comprise:
including the name-value pairs for the specified name extracted from the first and second documents in a results document in response to determining that the difference exceeds the threshold; and
processing the results document to generate the visualization highlighting displayed objects for the first and second documents rendered according to the different values provided for the specified name as indicated in the results document.

3. The computer program product of claim 1, wherein the operations further comprise:
receiving user input indicating thresholds for a plurality of names.

4. The computer program product of claim 1, wherein the operations further comprise:
rendering in a GUI the first and second documents; and
rendering visual highlighting in the rendered first and second documents for each rendered object having different values for a name in the first and second document that exceed any threshold provided for the name.

5. The computer program product of claim 4, wherein the operations further comprise:
receiving user input for an adjusted threshold for a name of the name-value pairs for display objects rendered in the GUI.

6. The computer program product of claim 4, wherein the operations further comprise:
determining whether a difference of extracted values, in the first and second documents, for a name exceeds an adjusted threshold provided for the name; and
rendering a display object in the first and second documents, without the visual highlighting, for the name in response to determining that the difference of the extracted values for the name does not exceed the adjusted threshold.

7. The computer program product of claim 1, wherein thresholds are provided for a plurality of names having values to determine whether differences in the value for the names having thresholds are to by visually highlighted.

8. The computer program product of claim 1, wherein the specified name comprises a name of an attribute to control rendering of a display object having a plurality of name-value pairs that define a position and stylistic information for content to render in a document for the display object, wherein there are thresholds for a plurality of the name-value pairs for display objects in the first and second documents, wherein the operations further comprise:
generating visualizations highlighting objects rendered according to different values provided for name-value pairs in the objects that exceed the thresholds provided for the name-value pairs in the objects.

9. The computer program product of claim 1, wherein the threshold is associated with a cause of a difference of a plurality of possible causes of the difference, wherein the operations further comprise:
determining whether a cause of the difference in values for the specified name exceeding the threshold comprises the cause associated with the threshold, wherein the visualization highlighting the difference for the specified name is generated in response to determining that the cause of the difference comprises the cause associated with the threshold.

10. A system for comparing documents, wherein the operations comprising:
a processor; and
a computer readable storage medium having program instructions embodied therewith, the program instructions executable by a processor to cause operations, the operations comprising:
extracting name-value pairs for objects in a first document, wherein the objects include code to control rendering of content in the first document in a graphical user interface (GUI), wherein each extracted name-value pair indicates a value for a name of an attribute in the first document;
extracting name value pairs for objects in a second document,;
determining whether a difference in values of a specified name indicated in the name-value pairs extracted from the first and second documents exceeds a threshold provided for the specified name; and
generating a visualization highlighting an object rendered according to different values provided for the specified name that are determined to exceed the threshold provided for the specified name.

11. The system of claim 10, wherein the operations further comprise:
including the name-value pairs for the specified name extracted from the first and second documents in a results document in response to determining that the difference exceeds the threshold; and
processing the results document to generate the visualization highlighting displayed objects for the first and second documents rendered according to the different values provided for the specified name as indicated in the results document.

12. The system of claim 10, wherein the operations further comprise:
rendering in a GUI the first and second documents; and
rendering visual highlighting in the rendered first and second documents for each rendered object having different values for a name in the first and second document that exceed any threshold provided for the name.

13. The system of claim 12, wherein the operations further comprise:
determining whether a difference of extracted values, in the first and second documents, for a name exceeds an adjusted threshold provided for the name; and
rendering a display object in the first and second documents, without the visual highlighting, for the name in response to determining that the difference of the extracted values for the name does not exceed the adjusted threshold.

14. The system of claim 10, wherein thresholds are provided for a plurality of names having values to determine whether differences in the value for the names having thresholds are to by visually highlighted.

15. The system of claim 10, wherein the threshold is associated with a cause of a difference of a plurality of possible causes of the difference, wherein the operations further comprise:
determining whether a cause of the difference in values for the specified name exceeding the threshold comprises the cause associated with the threshold, wherein the visualization highlighting the difference for the specified name is generated in response to determining that the cause of the difference comprises the cause associated with the threshold.

16. A method for comparing documents to be rendered on a computer monitor, comprising:
extracting name-value pairs for objects in a first document, wherein the objects include code to control rendering of content in the first document in a graphical user interface (GUI), wherein each extracted name-value pair indicates a value for a name of an attribute in the first document;
extracting name value pairs for objects in a second document,;
determining whether a difference in values of a specified name indicated in the name-value pairs extracted from the first and second documents exceeds a threshold provided for the specified name; and
generating a visualization highlighting an object rendered according to different values provided for the specified name that are determined to exceed the threshold provided for the specified name.

17. The method of claim 16, further comprising:
including the name-value pairs for the specified name extracted from the first and second documents in a results document in response to determining that the difference exceeds the threshold; and
processing the results document to generate the visualization highlighting displayed objects for the first and second documents rendered according to the different values provided for the specified name as indicated in the results document.

18. The method of claim 16, wherein the operations further comprise:
rendering in a GUI the first and second documents; and
rendering visual highlighting in the rendered first and second documents for each rendered object having different values for a name in the first and second document that exceed any threshold provided for the name.

19. The method of claim 18, further comprising:
determining whether a difference of extracted values, in the first and second documents, for a name exceeds an adjusted threshold provided for the name; and
rendering a display object in the first and second documents, without the visual highlighting, for the name in response to determining that the difference of the extracted values for the name does not exceed the adjusted threshold.

20. The method of claim 16, wherein thresholds are provided for a plurality of names having values to determine whether differences in the value for the names having thresholds are to by visually highlighted.

21. The method of claim 16, wherein the threshold is associated with a cause of a difference of a plurality of possible causes of the difference, further comprising:
determining whether a cause of the difference in values for the specified name exceeding the threshold comprises the cause associated with the threshold, wherein the visualization highlighting the difference for the specified name is generated in response to determining that the cause of the difference comprises the cause associated with the threshold.
